(19) United States
(12) Patent Application Publication
(10) Pub. No.: US 2020/0049235 A1
(43) Pub. Date: Feb. 13, 2020

(54) MODULAR GRAVITATIONAL ENERGY BELT (MGEB)

(71) Applicant: Dana Ng, west covina, CA (US)

(72) Inventor: Dana Ng, west covina, CA (US)

(21) Appl. No.: 16/537,612

(22) Filed: Aug. 11, 2019

Related U.S. Application Data
(60) Provisional application No. 62/718,286, filed on Aug. 13, 2018.

(51) Int. Cl. F16H 25/18; B25J 9/00

(52) U.S. Cl. CPC F16H 25/18; B25J 9/0006

(57) ABSTRACT

An energy scavenging device for increasing bi-pedal locomotion efficiency in powered exoskeletons, passive exoskeletons, & bi-pedal robots. The present inventive device, the modular gravitational energy belt (MGEB) includes a gravitational energy scavenging midsection which mechanically drives lower extremities. A double gear reduction drive unit is attached from the midsection to the upper-body for capturing gravitational potential energy generated via the shifting of upper body mass prior to each stride. This direct mechanical energy is then transferred via a bowden cable & tube system for driving lower extremities which are passively propped up in standing position with struts or springs. The method of mechanical energy transfer for lower extremities can be comprised of any well-known mechanical devices for transmitting mechanical force or energy. Placement of energy storage devices and drive train and other heavy mass components are preferably positioned in the upper half of the body where gravitational energy can be harvested.

### BACKGROUND OF THE INVENTION

### 1. Field of the Invention

The present invention relates generally to powered/unpowered exo-skeleton suits & bi-pedal robots and more specifically it relates to an energy scavenging device for increasing bi-pedal locomotion efficiency in powered exoskeletons, passive exoskeletons, & bi-pedal robots by harnessing stored gravitational potential energy in the upper body.

### 2. Description of the Prior Art

Powered exo-skeleton suits have been in use for years. Typically, a conventional powered exo-skeleton suit will have an upper-body carrying a load which may include an exoskeleton, payload, motors, & battery. The user attaches their body to the lower & upper extremities and then uses sensors to read the user's movements & provide mechanical assistance via electric motors. The user is usually tethered to a power source to provide power for driving the electrical motors used for bi-pedal locomotion. These powered exo-skeletons have not been put into practical use due to battery density constraints. The substantial energy usage required limits practical usage in real world applications. Bi-pedal locomotion in the conventional powered exo-skeleton suit also requires the user to run in awkward positions due to electrical drive train latency and in conjunction with an uneven center of gravity which will eventually cause injuries to the user's body & increase metabolic costs. While these devices may be suitable for the particular stationary purposes to which they address, they are not as suitable for increasing bi-pedal locomotion efficiency in powered/unpowered exoskeletons & bi-pedal robots.

In these respects, this modular gravitational energy belt (MGEB) according to the present invention substantially departs from the conventional concepts and designs of the prior art and in so doing provides an apparatus primarily developed for the purpose of increasing bi-pedal locomotion efficiency in powered exoskeletons, passive exoskeletons, & bi-pedal robots.

### SUMMARY OF THE INVENTION

Unlike bi-pedal robots, in powered exoskeletons, sensors & actuators are placed externally. The amount of upper-body weight placed externally exponentially increases the exo-skeleton user's need for shifting body weight prior to each stride. The MGEB's novel design uses the upper-body's stored gravitational potential energy and exploits the human body's natural need for shifting of body weight along the X rotational axis prior to each stride for balancing. Energy is scavenged via the initial lift & downward motion of the upper-body as well as the return to up-right position via passive knee struts. When compared to conventional powered exoskeletons, additional mass in the form of energy storage devices equates to a loss in efficiency due to the introduction of additional mass. The MGEB works paradoxically, additional mass introduced through larger energy storage devices, motors, payloads in the upper-body actually increases efficiency & generates additional gravitational potential energy for driving lower extremities.

Because the MGEB works by scavenging stored gravitational potential energy in the upper-body-circumstances, environment, & payload factors into it's efficiency. Efficiency is increased when overall upper-body weight is increased & weight distribution is spread further apart in the x horizontal direction. Jogging speed & terrain slope also increases the range of upper-body rotational x-axis shift prior to each stride for balancing center of gravity. Additional upper-body weight, uneven upper-body weight distribution, increased jog speed & traversal up sloped terrain are the largest disadvantages to modern known types of powered exo-skeleton suits. These modern disadvantages are the MGEB's greatest strengths giving the MGEB an exemplary symbiotic relationship with conventional powered exo-skeleton suits.

The present invention generally comprises a gravitational energy scavenging mid-section which mechanically drives lower extremities. A double gear reduction drive unit is used for amplifying the degree of upper-body tilt where direct mechanical energy is transferred through a bowden cable & tube system for driving lower extremities. The method of mechanical energy transfer for lower extremities can be comprised of any well-known mechanical devices for transmitting mechanical force or energy. Placement of energy scavenging device is preferably positioned in the midsection of the body where gravitational energy can be harvested.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary objective of the present invention is to provide an energy scavenging device for increasing bi-pedal locomotion efficiency in powered exoskeletons, passive exoskeletons, & bi-pedal robots.

A secondary objective is to provide an energy scavenging device that will overcome the energy storage/uneven weight distribution shortcomings of the prior art devices.

Another objective is to provide an energy scavenging device that outputs a high torque, low latency mechanical assistance to electrical motors which drive lower extremities.

A further objective is to provide an energy scavenging device that reduces the strain on stationary standing position legs and back via passive struts/springs.

Another objective is to provide an energy scavenging device to bi-pedal robotic devices or ones that have upper-bodies.

Other objectives and advantages of the present invention will become obvious to the reader and it is intended that these objectives and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

The detailed description of some embodiments of the invention is made below with reference to the accompanying figures, wherein like numerals represent corresponding sections of the figures. FIGS. 1-12 show various views of three exemplary embodiments of the subject technology. FIG. 1 shows a front perspective view of version 3 of a powered exoskeleton suit, with mechanical movement indication arrows in accordance with exemplary embodiments of the subject technology.

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a front mechanical movement illustration of the present invention inserted into the possible embodiment of a powered exo-skeleton suit.

FIG. 2 is an isometric perspective view of the present invention inserted into the possible embodiment of a powered exo-skeleton suit.

FIG. 3 is a side view of the present invention inserted into the possible embodiment of a powered exo-skeleton suit.

FIG. 4 is an isometric mid-section view of the present invention inserted into the possible embodiment of a powered exo-skeleton suit.

FIG. 5 is a close-up front view of the present invention inserted into the possible embodiment of a powered exo-skeleton suit.

FIG. 6 is an isometric perspective view of the knee attachments of the present invention inserted into the possible embodiment of a powered exo-skeleton suit.

FIG. 7 is an isometric perspective view of the present invention inserted into the upper-body of the possible embodiment of a powered exo-skeleton suit.

FIG. 8 is an isometric perspective view of the lower extremities of the possible embodiment of a powered exo-skeleton suit with mechanical MGEB ankle drivers.

FIG. 9 is a front view of the lower extremities of the possible embodiment of a powered exo-skeleton suit with mechanical MGEB ankle drivers.

FIG. 10 is a side view of the lower extremities of the possible embodiment of a powered exo-skeleton suit with mechanical MGEB ankle drivers.

FIG. 11 is a detailed isometric view of the present invention MGEB system isolated from an exo-skeleton suit.

FIG. 12 is a detailed front view of the present invention MGEB system isolated from an exo-skeleton suit.

### DESCRIPTION OF THE PREFERRED EMBODIMENTS

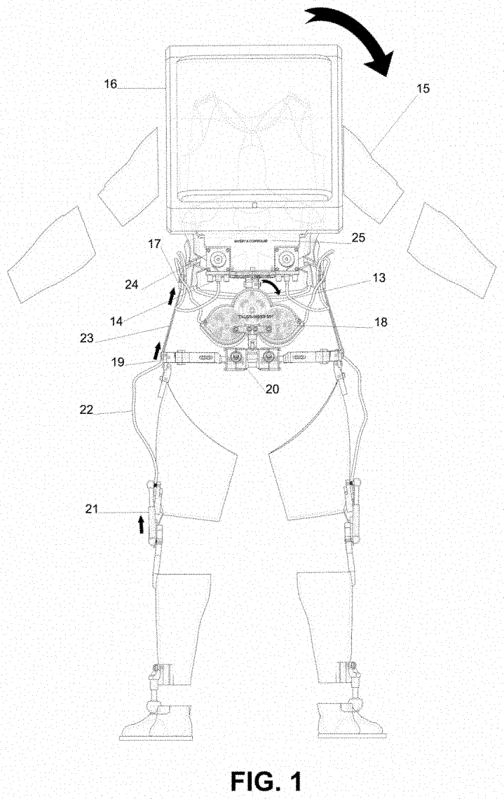

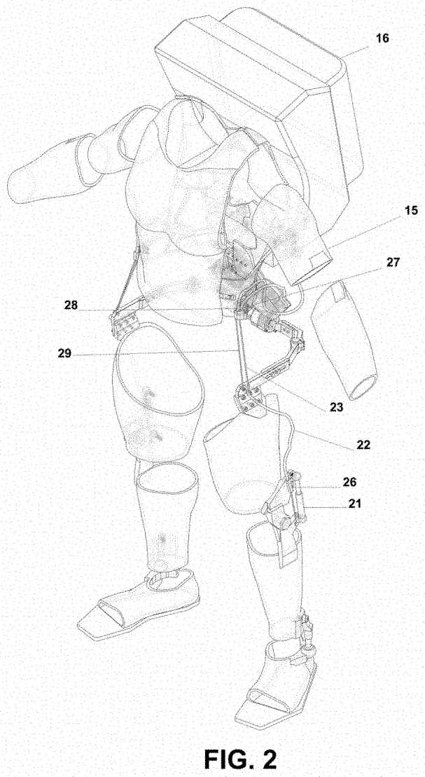

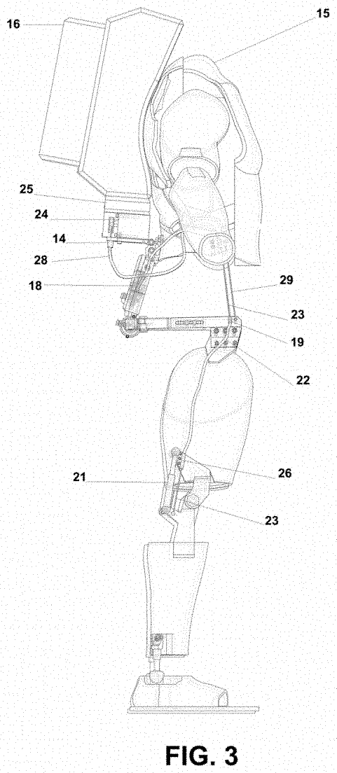

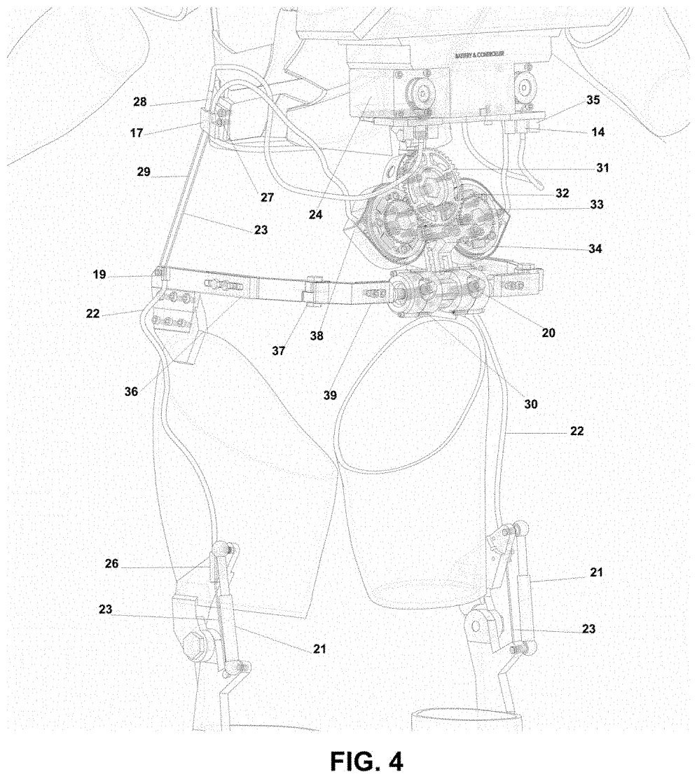

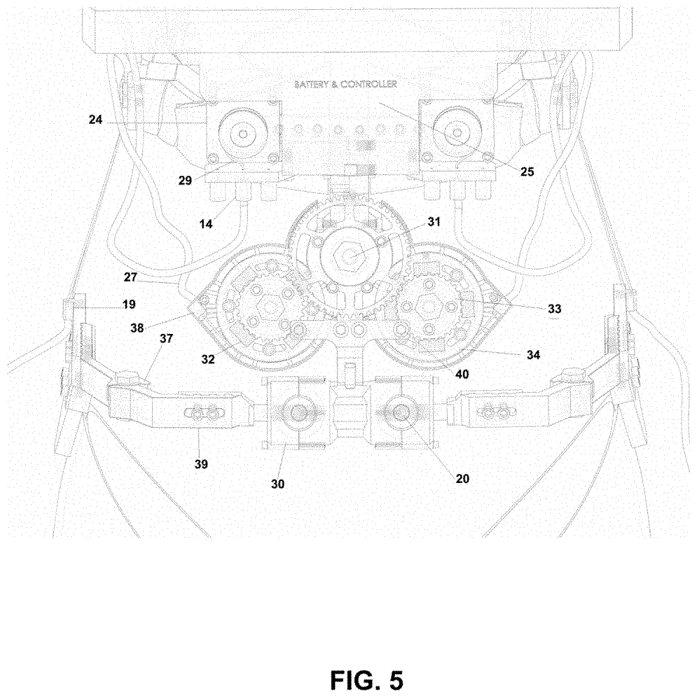

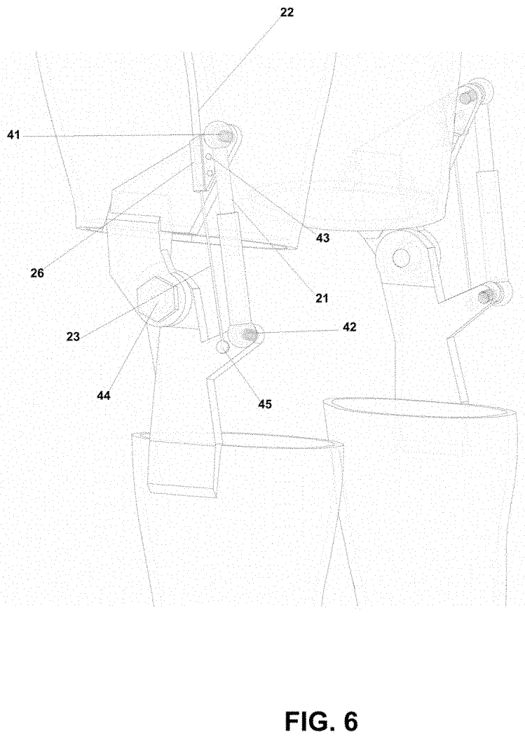

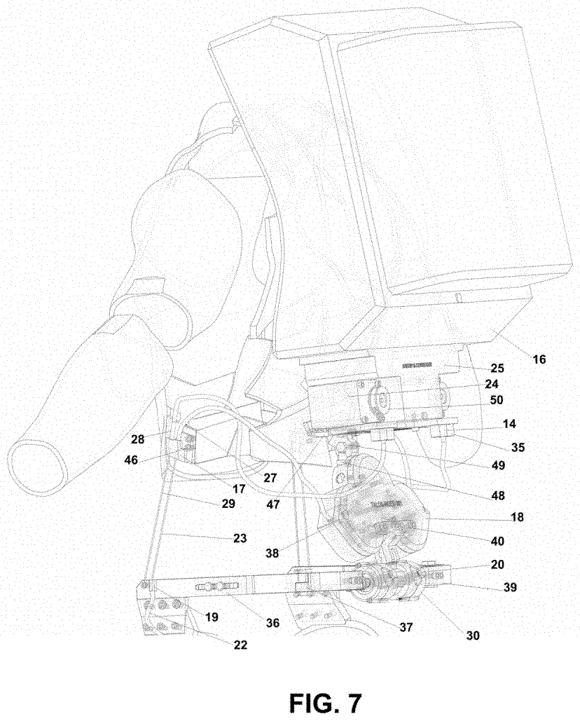

Turning now descriptively to the drawings, in which similar reference characters denote similar elements throughout the several views, FIGS. 1 through 7 illustrate an energy scavenging device, which comprises a double gear reduction drive unit 18, 31-34 connected to a set of bowden cable & housing mechanical energy transfer system 17, 19, 22, 23, 26, 27, 29, 38, 45 which drives/compresses passive struts 21 & springs 20 located in the knees & hips. The x-rotational axis of the powered exo-skeleton's lower back is connected to a double gear reduction drive unit 18 which amplifies the small rotational shifts in the upper-body during the balancing phase prior to each stride. Electrical motors 24 which drive bowden tube 28 & cable 29 system for additional battery attenuated assistance during the tilting of the upper-body prior to each stride are positioned within the upper-body's midsection. The upper-body's stored gravitational potential energy comprises of the payload 16, exo-skeleton 15, motors 24, battery and controller 25, and the user's upper body. Wherein the upper-body's stored gravitational potential energy separates from the lower extremities everything below 18 is considered the lower-body. The double gear reduction drive unit 18 and the bowden tube & cable system 23, 27, 17, 22, 26 is for driving of the lower extremities & may be comprised of any well-known structures for transferring mechanical force or energy. The double gear reduction drive unit 18 is preferably positioned at the midsection of an exo-skeleton suit for maximum efficiency.

Broadly, embodiments of the disclosed invention provide exoskeletons & bi-pedal robots a modular integration system for converting stored gravitational potential energy to use-able mechanical energy in driving/assisting an exo-skeleton suit or bi-pedal robot in the balancing phase before a stride. As will be appreciated, the gravitational potential energy is used to simultaneously lift the swing leg & bend the swing knee. By utilizing stored gravitational potential energy supplied by the system's upper body weight, upright bi-pedal mobility efficiency is drastically increased. Referring to FIG. 1, a powered exoskeleton suit is shown according to an exemplary embodiment with mechanical movement indication arrows. While aspects of the present invention are being described with respect to a powered exo-skeleton suit, it will be understood that the novel features and benefits may also be applicable to unpowered exo-skeleton suits & bi-pedal robots. Exemplary embodiments are depicted as bi-pedal powered exo-skeleton suits.

In addition, elements will be described primarily in the singular form for the sake of illustration. In an exemplary embodiment, twin electrical motors 24 may be included for assisted x-rotational axis of the upper robot body. The MGEB system works together with a conventional powered exo-skeleton system to provide mechanical drive assistance to electrically powered motors 24. The cable 23, 29 may be sheathed in a bowden cable housing 27, 28, 22. The lower cable 23 may be connected in parallel to a knee strut 21, which in turn may be connected to a knee joint 45. In an exemplary embodiment, the system includes a midsection central x-axis rotational pivot point 31 which is attached to the large gear which drives a pair of secondary gears 33 simultaneously. The secondary gears 33 are bolted to a larger wheel 34 which are attached to a pair of cables 23 used for driving the passive knee struts 21 and passive ankle springs 53-54 during operation. In operation, the hip joint may be similar to that of a human internal skeleton system. The system may move shifting body weight to one leg while maintaining balance and results in a natural lift of the active leg. The tugging on housing 19 through cable 23 provides for a natural lift of the hips.

FIG. 1 shows the range of motion for a system according to an exemplary embodiment. This natural shifting of body weight which simultaneously results in the lifting of the active leg up to an inch is an integral aspect for all bi-pedal organisms. The exo-skeleton suit may mimic that process by placing all primary rotations of the hip joint embedded deep and near the spine rather than the exterior of the hip, the posterior swivel ball joint spring mount 20. Furthermore, this hip joint has limited range(hip lateral rotation limiter 37 & posterior pelvic ball swivel joint 20 abduction limiter) to prevent excessive shifting of body weight which would result in an uneven body weight distribution and eventual collapse. The knee strut 21 provides the majority of the passive mechanical force that keeps the system standing upright. Because the strut 21 is designed to hold up so much weight, retraction of the struct 21 may require an equal amount of force. Because bi-pedal movement only requires a slight bending of the knee, the knee struts 21 can be retracted via forces created by the necessary process of shifting upper body weight. The knee struts 21 attached to the cable 23 (which is also attached to the upper cable 27), are driven by the tilting of the upper body to the left or right of the pivot point 31. The initial force of tilting the upper body may be initialized by the user or via internal motors (robots). The stored gravitational potential energy from the upright position may then be captured and aid in the remainder of the tilting needed for upper body weight shifting to one leg. The necessary process of shifting body weight to one leg is then exploited for bending of the active knee joint and lifting of the active leg (via, for example, hydraulics or steel cable ties) which is then aided by gravitational potential energy.

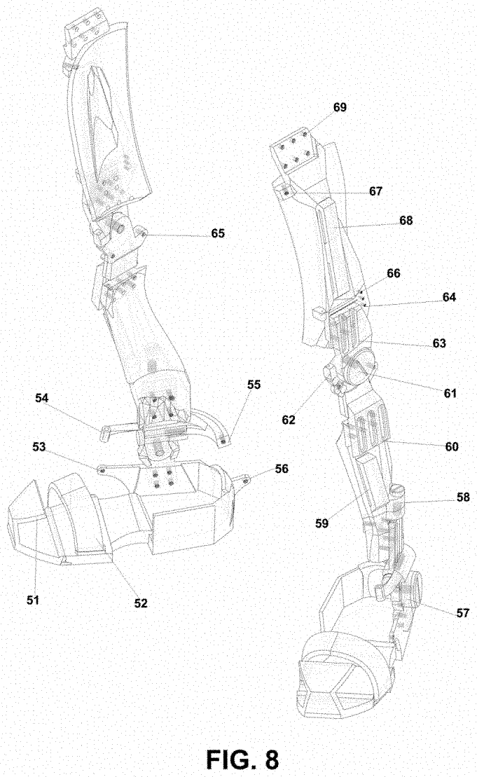

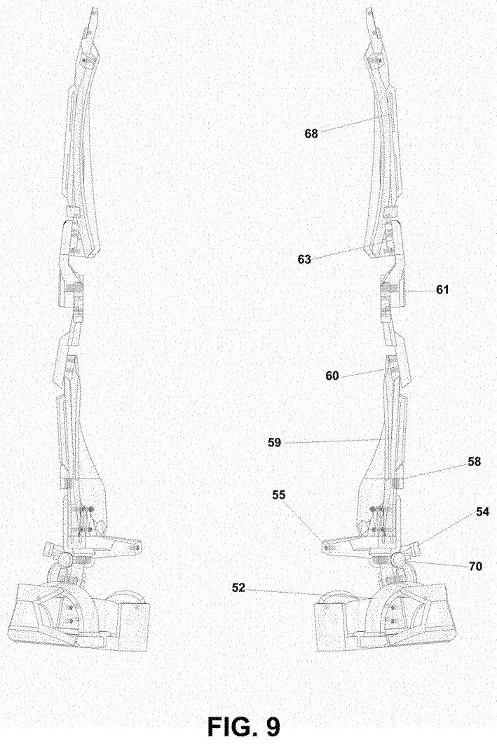

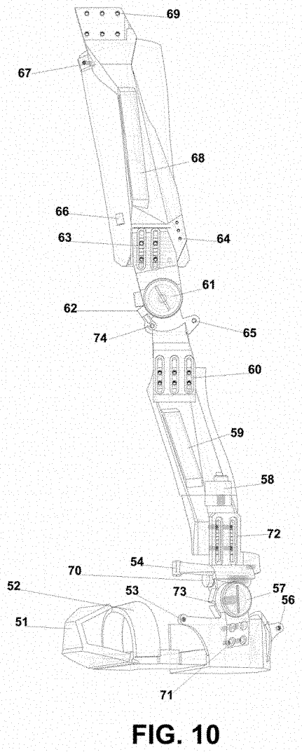

FIGS. 8-10 show another exemplary embodiment in the form of the lower extremities of an exoskeleton. As shown, the exo-skeleton may also leverage the potential energy available from the weight shift in the upper body which can be used to assist the lower extremities in lifting of the knee 63-65 & feet 53, 54 during movement. As can be seen, a cable system connects the lower body joints from a central pivot point positioned proximate the hip area so that when the hip shifts its weight with the upper body, the potential energy is transferred via bowden cable & housing to the lower extremity joints to raise the lower extremities. Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

In FIGS. 8-10 of the drawings, the lower extremities are preferably symbiotic to the user in shape. It can be appreciated by one skilled in the art that the lower extremities maybe fully modular & adjustable via sliding bolt mounts 72, 60, 63. The lower extremities are preferably attachable with straps via strap mounts 68, 59. However, it can be appreciated that the lower extremities can have various other shapes including curved shapes for user compatibility.

The lower extremities may be solid in structure or may be comprised of a hollow structure. The lower extremities is preferably comprised of a metal such as carbon steel, aluminum or carbon fiber. It can be appreciated that the lower extremities may be comprised of any common material such as metal or plastic.

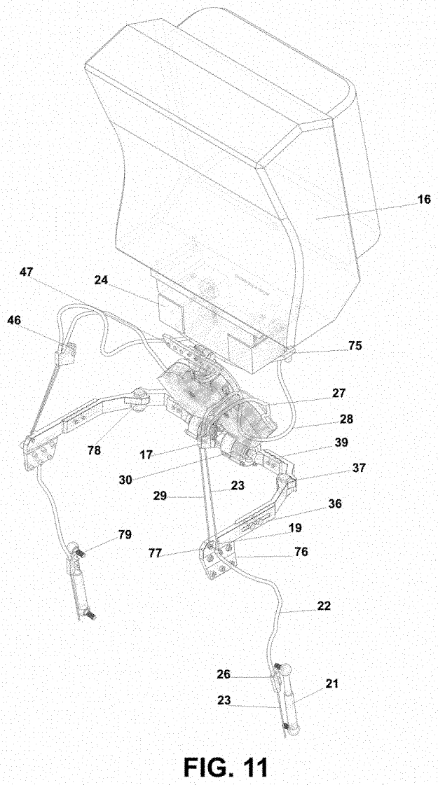

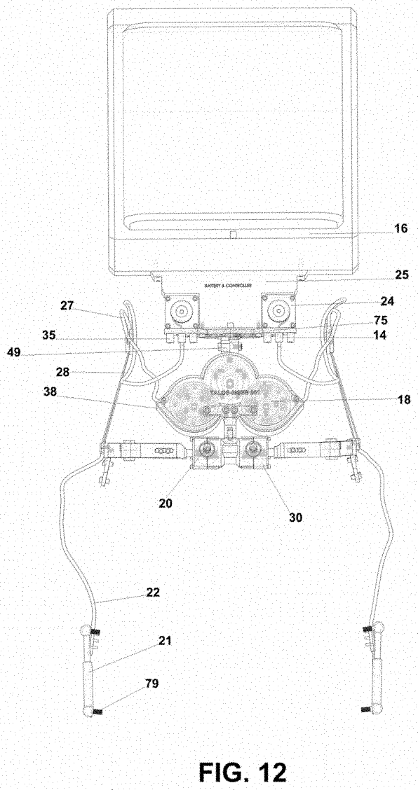

FIGS. 11 and 12 display a detailed isometric & front view of the present invention MGEB system isolated from an exo-skeleton. The payload 16 is directly mounted to the platform 75 & or can be reinforced to the exo-skeleton user with straps. The platform 75 also mounts the dual electric motors 24 & battery/controller 25 which is the primary electrically assisted drive train for the MGEB. The platform 75 is attached via a bolt hinge mechanism to the y-rotational axis hinge 19 & the upper-body attachment plate 47 which then can be directly mounted to the upper-body of an exo-skeleton suit. The y-rotational axis hinge 49 is an extension of the z-rotational axis 48 hinge which is bolt mounted to the midsection central x-axis rotational pivot point 31 which is the primary driving mechanism for transferring stored upper-body gravitational energy. The combination of screw-on struts 79, hip mounting plates 76, midsection abduction mounting bolts 46, anterior pelvic size adjustment plates 36 & posterior pelvic size adjustment plates 39 these modular elements of the MGEB allows for seamless multi-platform integration.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention

1. An energy scavenging device, comprising of a stored gravitational energy scavenging system positioned in the mid-section which mechanically drives lower extremities via stored upper-body gravitational potential energy, wherein said upper-body is having a single rotational axis for scavenging stored gravitational energy between each step.

2. The energy scavenging device of claim 1, wherein said stored upper-body gravitational potential energy is used to drive knee joints.

3. The energy scavenging device of claim 1, wherein said stored upper-body gravitational potential energy is used to drive ankle joints.

4. The energy scavenging device of claim 1, wherein said stored upper-body gravitational potential energy is used to drive hip joints.

5. The exo-skeleton upper-body of claim 2, wherein said stored upper-body gravitational potential energy utilizes a bowden cable/tube system for driving knee joints.

6. The exo-skeleton upper-body of claim 3, wherein said stored upper-body gravitational potential energy utilizes a bowden cable/tube system for driving ankle joints.

7. The exo-skeleton upper-body of claim 4, wherein said stored upper-body gravitational potential energy utilizes a bowden cable/tube system for driving hip joints.

8. The energy scavenging device of claim 1, wherein said lower extremities utilizes passive springs or struts.

9. The energy scavenging device of claim 1, wherein said stored upper-body gravitational potential energy utilizes a gearbox for amplifying degree of upper-body rotation.
